(19) United States
(12) Patent Application Publication
(10) Pub. No.: US 2025/0099876 A1
(43) Pub. Date: Mar. 27, 2025

(54) SYSTEM AND METHODS OF USING A FILTERING BAG

(71) Applicant: Oceaneering International, Inc., Houston, TX (US)

(72) Inventors: John FRICKER, Taylor Lake Village, TX (US); Tatsuya ARAI, League City, TX (US)

(73) Assignee: Oceaneering International, Inc., Houston, TX (US)

(21) Appl. No.: 18/899,198

(22) Filed: Sep. 27, 2024

Related U.S. Application Data
(60) Provisional application No. 63/585,867, filed on Sep. 27, 2023.

(51) Int. Cl. B01D 19/00; C02F 1/20; C02F 1/44; C02F 103/00; E03D 13/00

(52) U.S. Cl. CPC B01D 19/0031; B01D 19/0063; C02F 1/20; C02F 1/44; E03D 13/005; C02F 2103/005; C02F 2201/005

(57) ABSTRACT

A two-phase fluid may be separated into a first phase fluid and a second phase fluid using a two-phase fluid separator that comprises a first fluid actuator, a two-phase fluid processor; an enclosure, comprising an interior and configured to at least partially contain the first phase fluid; a dual-layer bag, disposed at least partially within the interior of the enclosure, which comprises an inner bag comprising a porous membrane configured to contain the second phase fluid but allow the first phase fluid to pass through the porous membrane and an outer bag, comprising a material that is impermeable to the first phase fluid and the second phase fluid; a source fluid pathway; a result fluid pathway; a second actuator; an escape fluid pathway; and a first fan.

### CROSS-REFERENCE TO RELATED APPLICATIONS

This application claims priority through U.S. Provisional Application 63/585,867 filed on Sep. 27, 2023.

### BACKGROUND OF THE INVENTION

Separators may be required for use as part of a urinal to separate urine and air, especially as it applies to separating two-phase fluids in microgravity. Referring generally to FIG. 2, traditionally in zero-G, a urinal sucks both gas and liquid into the urinal using reduced pressure and separates liquid from gas with a spin separator in which liquid touches and adheres to a spinning drum wall which slings the liquid out to the sides. The spinning liquid rams into a pitot tube which pressurizes the liquid and pushes it out of the drum. These systems are large, have moving parts, and are susceptible to clogging.

In U.S. Pat. No. 11,365,137, referring to FIG. 1, wastewater (comprising urine, greywater, blackwater, or the like or a combination thereof) is stored in the tank. As the process starts, the pump circulates wastewater in the loop. The redox cell electrochemically processes wastewater to oxidize and reduce wastewater constituents. The gas bubbles and foams generated by the electrochemical process leave the wastewater loop from porous lumens in a gas-liquid contactor (GLC). The degassed wastewater returns to the tank and recirculates until the electrochemical process and evaporation are completed.

### BRIEF DESCRIPTION OF DRAWINGS

Various figures are included herein which illustrate aspects of embodiments of the disclosed inventions.

FIG. 1 is a flow diagram for an electro-oxidation membrane evaporator wastewater processor;

FIG. 2 is a flow diagram for a traditional gas-liquid separation system;

FIG. 3 is a block diagram for of a first embodiment of the disclosed invention;

FIG. 4 is a block diagram for of a second embodiment of the disclosed invention; and

FIG. 5 is a block diagram for of a third embodiment of the disclosed invention.

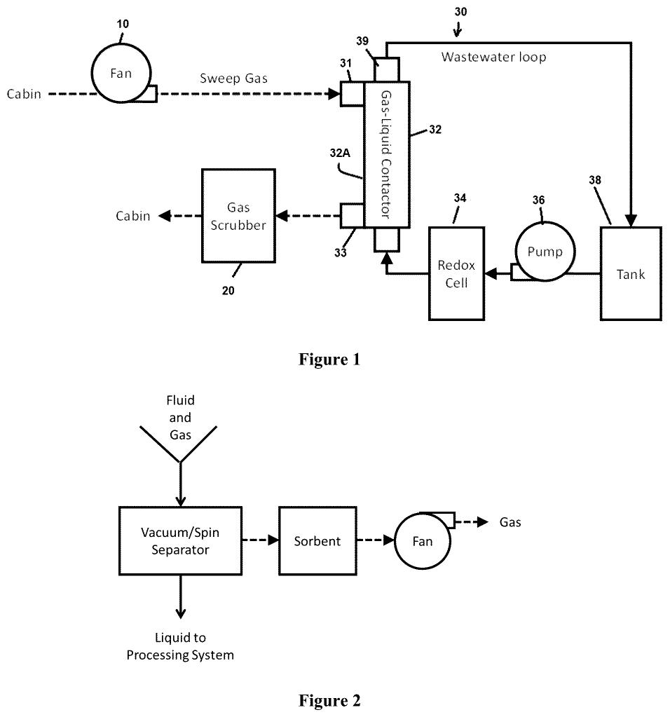

### DETAILED DESCRIPTION OF EMBODIMENTS OF THE INVENTION

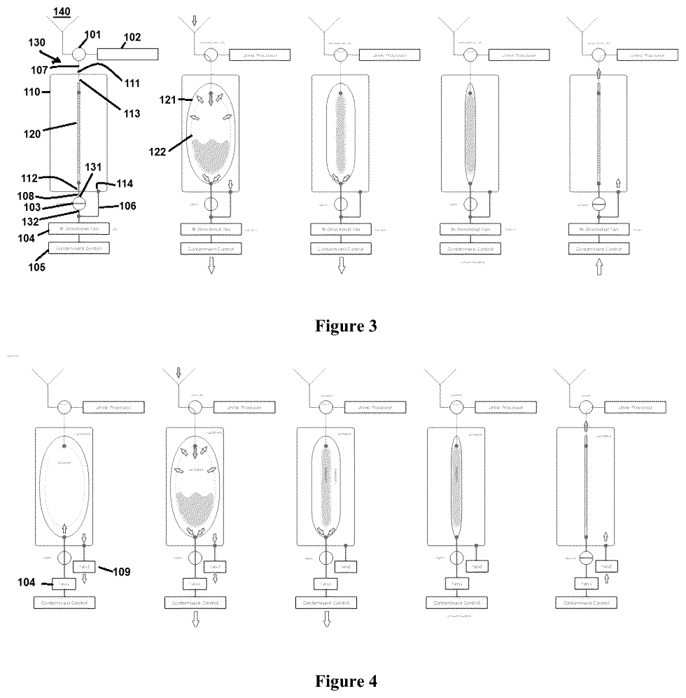

In a first embodiment, referring generally to FIG. 3, a two-phase fluid separator for a two-phase fluid, where the two-phase fluid typically comprises at least a first phase fluid and a second phase fluid, comprises a first fluid actuator 130; two-phase fluid processor 102 in fluid communication with first fluid inlet 111; enclosure 110, comprising an interior and configured to at least partially contain the first phase fluid; dual-layer bag 120 disposed at least partially within the interior of enclosure 110; source fluid pathway 113 in fluid communication with first bidirectional fluid pathway 107, where source fluid pathway 113 is attached to a top of inner bag 122 and configured to penetrate through inner bag 122 and seal to outer bag 121; result fluid pathway 108 in fluid communication with a bottom of outer bag 121; second actuator 103 in fluid communication with result fluid pathway 108; escape fluid pathway 106 in fluid communication with the interior of enclosure 110; and first fan 104 in fluid communication with second actuator fluid outlet 132 and escape fluid pathway 106. The first phase fluid typically comprises a gas, e.g., air, and the second phase fluid typically comprises a liquid, e.g., urine.

Dual-layer bag 120 comprises inner bag 122, comprising a porous membrane configured to contain the second phase fluid but allow the first phase fluid to pass through the porous membrane, and outer bag 121, comprising a material that is impermeable to the first phase fluid and the second phase fluid.

In typical embodiments, first fluid actuator 130 comprises one or more first fluid inlets 111; one or more first bidirectional fluid pathways 107; one or more first fluid outlets 112; and one or more fluid valves 101 in fluid communication with at least one first fluid inlet 111.

Fluid valves 101 typically comprise a first closed position; a first open position, allowing fluid flow between first fluid inlet 111 and first bidirectional fluid pathway 107 and blocking fluid flow between first fluid outlet 112 and first bidirectional fluid pathway 107, and a second open position, blocking fluid flow between first fluid inlet 111 and first bidirectional fluid pathway 107 and allowing fluid flow between first fluid outlet 112 and first bidirectional fluid pathway 107.

Second actuator 103 typically comprises second actuator fluid inlet 131; second actuator fluid outlet 132; a first closed position (shown at first portion of FIG. 3); and a first open position (shown at second portion of FIG. 3) allowing fluid flow between the second actuator fluid inlet and the second actuator fluid outlet. Second actuator 103 may be in fluid communication with escape fluid pathway 106, where the first closed position further blocks fluid flow from second actuator 103 and escape fluid pathway 106 and the first open position further allows fluid flow between second actuator fluid inlet 131 and escape fluid pathway 106.

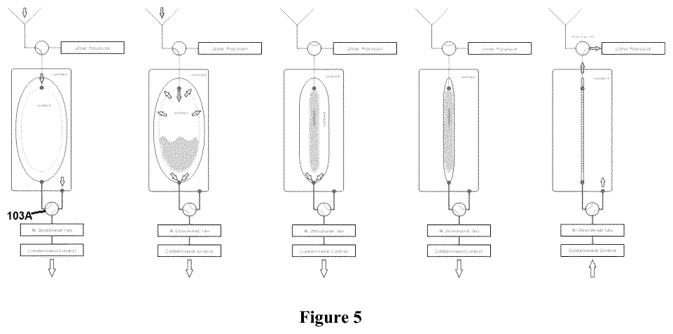

In certain embodiments, second actuator 103 comprises multi-position valve 103A (FIG. 5), comprising a first closed position (shown at first portion of FIG. 5); a first open position allowing fluid flow between first fan 104 and result fluid pathway 108 via a first internal valve fluid pathway (shown at first portion of FIG. 5); a second closed position (shown at second portion of FIG. 5); and a second open position allowing fluid flow between first fan 104 and escape fluid pathway 106 (shown at last portion of FIG. 5) via a second internal valve fluid pathway.

In embodiments, first fan 104 comprises a bidirectional fan. In embodiments, second fan 109 (FIG. 4), which may be a bidirectional fan, may be present and in fluid communication with escape fluid pathway 106.

In embodiments, contaminant control 105 may be present and in fluid communication with result fluid pathway 108 and with first fan 104.

In the operation of exemplary methods, referring back to FIG. 3, a two-phase fluid may be separated into a first phase fluid and a second phase fluid using the two-phase fluid separator described above by fluidly connecting fluid valve 101 to a source of two-phase fluid 140; placing fluid valve 101 into its first open position; placing second actuator 103 into its first open position; and using first fan 104 to draw the two-phase fluid from the source of two-phase fluid into dual-layer bag 120. At a predetermined time, fluid valve 101 is placed into its first closed position, e.g., either automatically such as by a controller (not shown in the figures) or manually, and second actuator 103 used to evacuate the first phase fluid from inner bag 121 into outer bag 122, thereby evacuating the first phase fluid from inner bag 121 into the interior of enclosure 110 and gathering the second phase fluid in inner bag 121. At a further predetermined time, once all liquid is collected inside inner bag 121, fluid valve 101 is placed into its second open position, either automatically via the controller or manually, thereby preventing further fluid flow from dual-layer bag 120 to first fan 104, and the interior of enclosure 110 pressurized, thereby forcing the second phase fluid from dual-layer bag 120 into first bidirectional fluid pathway 107.

In embodiments, first fan 104 may be used to reduce pressure in enclosure 110 so dual-layer bag 120 can expand to provide volume for accepting fluids such as wastewater.

In embodiments, a need to change or clean filters may be reduced or eliminated, thereby reducing maintenance time, and there may be no need to have a separate brine bag into which a fluid such as wastewater will drain.

In embodiments where first fan 104 comprises a bidirectional fan, preventing further fluid from dual-layer bag 120 to first fan 104 may comprise placing second actuator 103 into its first closed position. In this embodiment, pressurizing the interior of enclosure 110 comprises using bidirectional first fan 104 to force a fluid into the interior of enclosure 110, thereby forcing the second phase fluid from dual-layer bag 120 into first bidirectional fluid pathway 107.

In embodiments comprising second fan 109 (FIG. 4) in fluid communication with escape fluid pathway 106, preventing further fluid from dual-layer bag 120 to first fan 104 may comprise placing second actuator 103 into its first closed position and pressurizing the interior of enclosure 110 may comprise using second fan 109 to pressurize the interior of enclosure 110, thereby forcing the second phase fluid from dual-layer bag 120 into first bidirectional fluid pathway 107.

In embodiments where first fan 104 comprises a bidirectional fan and second actuator 103 comprises multi-position valve 103A (FIG. 5) as described above, preventing further fluid flow from dual-layer bag 120 to first fan 104 typically comprises placing multi-position valve 103A into its second closed position and concurrently placing the multi-position valve into its second open position. Pressurizing the interior of enclosure 110 further comprises using bidirectional fan 104 to force a fluid into the interior of enclosure 110 through the second internal valve pathway, thereby forcing the second phase fluid from dual-layer bag 120 into first bidirectional fluid pathway 107.

It is noted that this disclosed invention can be used to separate other fluids from gas besides urine.

The foregoing disclosure and description of the inventions are illustrative and explanatory. Various changes in the size, shape, and materials, as well as in the details of the illustrative construction and/or an illustrative method may be made without departing from the spirit of the invention.

1. A two-phase fluid separator for a two-phase fluid comprising a first phase fluid and a second phase fluid, comprising:
a) a first fluid actuator, comprising:
i) a first fluid inlet;
ii) a first bidirectional fluid pathway;
iii) a first fluid outlet; and
iv) a fluid valve in fluid communication with the first fluid inlet, comprising:
(1) a first closed position;
(2) a first open position allowing fluid flow between the first fluid inlet and the first bidirectional fluid pathway and blocking fluid flow between the first fluid outlet and the first bidirectional fluid pathway; and
(3) a second open position blocking fluid flow between the first fluid inlet and the first bidirectional fluid pathway and allowing fluid flow between the first fluid outlet and the first bidirectional fluid pathway;
b) a two-phase fluid processor in fluid communication with the first fluid inlet;
c) an enclosure, comprising an interior and configured to at least partially contain the first phase fluid;
d) a dual-layer bag disposed at least partially within the interior of the enclosure, comprising:
i) an inner bag comprising a porous membrane configured to contain the second phase fluid but allow the first phase fluid to pass through the porous membrane; and
ii) an outer bag, comprising a material that is impermeable to the first phase fluid and the second phase fluid;
e) a source fluid pathway in fluid communication with the first bidirectional fluid pathway, the source fluid pathway attached to a top of the inner bag and configured to penetrate through the inner bag and seal to the outer bag;
f) a result fluid pathway in fluid communication with a bottom of the outer bag;
g) a second actuator in fluid communication with the result fluid pathway, the second actuator comprising:
i) a second actuator fluid inlet;
ii) a second actuator fluid outlet;
iii) a first closed position; and
iv) a first open position allowing fluid flow between the second actuator fluid inlet and the second actuator fluid outlet;
h) an escape fluid pathway in fluid communication with the interior of the enclosure; and
i) a first fan in fluid communication with the second actuator fluid outlet and the escape fluid pathway.

2. The two-phase fluid separator for a two-phase fluid comprising a first phase fluid and a second phase fluid of claim 1, wherein the first phase fluid comprises a gas and the second phase fluid comprises a liquid.

3. The two-phase fluid separator for a two-phase fluid comprising a first phase fluid and a second phase fluid of claim 2, wherein the gas comprises air.

4. The two-phase fluid separator for a two-phase fluid comprising a first phase fluid and a second phase fluid of claim 2, wherein the liquid comprises urine.

5. The two-phase fluid separator for a two-phase fluid comprising a first phase fluid and a second phase fluid of claim 1, wherein the first fan comprises a bidirectional fan.

6. The two-phase fluid separator for a two-phase fluid comprising a first phase fluid and a second phase fluid of claim 1, further comprising a containment control in fluid communication with the first fan.

7. The two-phase fluid separator for a two-phase fluid comprising a first phase fluid and a second phase fluid of claim 1, wherein the second actuator is in fluid communication with the escape fluid pathway, the first closed position further blocking fluid flow from the second actuator and the escape fluid pathway and the first open position further allowing fluid flow between the second actuator fluid inlet and the escape fluid pathway.

8. The two-phase fluid separator for a two-phase fluid comprising a first phase fluid and a second phase fluid of claim 1, further comprising a second fan in fluid communication with the escape fluid pathway.

9. The two-phase fluid separator for a two-phase fluid comprising a first phase fluid and a second phase fluid of claim 8, wherein the second fan comprises a bidirectional fan.

10. The two-phase fluid separator for a two-phase fluid comprising a first phase fluid and a second phase fluid of claim 1, wherein the second actuator comprises a multi-position valve, comprising:
a) a first closed position;
b) a first open position allowing fluid flow between the first fan and the result fluid pathway via a first internal valve fluid pathway;
c) a second closed position; and
d) a second open position allowing fluid flow between the first fan and the escape fluid pathway via a second internal valve fluid pathway.

11. A method of separating a two-phase fluid into a first phase fluid and a second phase fluid using a two-phase fluid separator for a two-phase fluid comprising a first phase fluid and a second phase fluid that comprises a first fluid actuator comprising a first fluid inlet, a first bidirectional fluid pathway, a first fluid outlet, and a fluid valve in fluid communication with the first fluid inlet where the fluid valve comprises a first closed position, a first open position allowing fluid flow between the first fluid inlet and the first bidirectional fluid pathway and blocking fluid flow between the first fluid outlet and the first bidirectional fluid pathway, and a second open position blocking fluid flow between the first fluid inlet and the first bidirectional fluid pathway and allowing fluid flow between the first fluid outlet and the first bidirectional fluid pathway; a two-phase fluid processor in fluid communication with the first fluid inlet; an enclosure, comprising an interior and configured to at least partially contain the first phase fluid; a dual-layer bag, disposed at least partially within the interior of the enclosure, comprising an inner bag comprising a porous membrane configured to contain the second phase fluid but allow the first phase fluid to pass through the porous membrane and an outer bag, comprising a material that is impermeable to the first phase fluid and the second phase fluid; a source fluid pathway in fluid communication with the first bidirectional fluid pathway where the source fluid pathway is attached to a top of the inner bag and configured to penetrate through the inner bag and seal to the outer bag; a result fluid pathway in fluid communication with a bottom of the outer bag; a second actuator in fluid communication with the result fluid pathway, the second actuator comprising a second actuator fluid inlet, a second actuator fluid outlet, a first closed position, and a first open position allowing fluid flow between the second actuator fluid inlet and the second actuator fluid outlet; an escape fluid pathway in fluid communication with the interior of the enclosure; and a first fan in fluid communication with the second actuator fluid outlet and the escape fluid pathway, the method comprising:
a) fluidly connecting the fluid valve to a source of two-phase fluid;
b) placing the fluid valve into its first open position;
c) placing the second actuator into its first open position;
d) using the first fan to draw the two-phase fluid from the source of two-phase fluid into the dual-layer bag;
e) at a first predetermined time, placing the fluid valve into its first closed position;
f) using the second actuator to evacuate the first phase fluid from the inner bag into the outer bag, evacuate the first phase fluid from the inner bag into the interior of the enclosure, and gather the second phase fluid in the inner bag; and
g) at a second predetermined time, once all liquid is collected inside the inner bag,
i) placing the fluid valve into its second open position;
ii) preventing further fluid from the dual-layer bag to the first fan; and
iii) pressurizing the interior of the enclosure, thereby forcing the second phase fluid from the dual-layer bag into the first bidirectional fluid pathway.

12. The method of separating a two-phase fluid into a first phase fluid and a second phase fluid of claim 11, further comprising using the first fan to reduce pressure in the enclosure so the dual-layer bag can expand to provide volume for accepting a liquid.

13. The method of separating a two-phase fluid into a first phase fluid and a second phase fluid of claim 11, wherein:
a) the first fan comprises a bidirectional fan;
b) preventing further fluid from the dual-layer bag to the first fan comprises placing the second actuator into its first closed position; and
c) pressurizing the interior of the enclosure comprises using the bidirectional fan to force a fluid into the interior of the enclosure, thereby forcing the second phase fluid from the dual-layer bag into the first bidirectional fluid pathway.

14. The method of separating a two-phase fluid into a first phase fluid and a second phase fluid using the two-phase fluid separator for a two-phase fluid of claim 11, wherein:
a) the two-phase fluid separator further comprises a second fan in fluid communication with the escape fluid pathway;
b) preventing further fluid from the dual-layer bag to the first fan comprises placing the second actuator into its first closed position; and
c) pressurizing the interior of the enclosure comprises using the second fan to pressurize the interior of the enclosure, thereby forcing the second phase fluid from the dual-layer bag into the first bidirectional fluid pathway.

15. The method of separating a two-phase fluid into a first phase fluid and a second phase fluid using the two-phase fluid separator for a two-phase fluid of claim 11, wherein:
a) the first fan comprises a bidirectional fan;
b) the second actuator comprises a multi-position valve, comprising a first closed position, a first open position allowing fluid flow between the first fan and the result fluid pathway via a first internal valve fluid pathway, a second closed position, and a second open position allowing fluid flow between the first fan and the escape fluid pathway via a second internal valve fluid pathway;
c) preventing further fluid from the dual-layer bag to the first fan comprises placing the multi-position valve into its second closed position and placing the multi-position valve into its second open position; and
d) pressurizing the interior of the enclosure further comprises using the bidirectional fan to force a fluid into the interior of the enclosure through the second internal valve fluid pathway, thereby forcing the second phase fluid from the dual-layer bag into the first bidirectional fluid pathway.
